(19) United States
(12) Patent Application Publication
(10) Pub. No.: US 2024/0356225 A1
(43) Pub. Date: Oct. 24, 2024

(54) Electronic Devices with Multi-Substrate Stacked Patch Antennas

(71) Applicant: Apple Inc., Cupertino, CA (US)

(72) Inventors: Trang T. Thai, San Diego, CA (US); Jennifer M. Edwards, San Francisco, CA (US); Sidharth S. Dalmia, San Jose, CA (US); Menglu Li, San Jose, CA (US); Taegui Kim, San Jose, CA (US); Hai H. Ta, San Diego, CA (US)

(21) Appl. No.: 18/306,063

(22) Filed: Apr. 24, 2023

(51) Int. Cl. H01Q 9/04; H01Q 1/14; H01Q 1/48; H01Q 1/50; H01Q 23/00

(52) U.S. Cl. CPC H01Q 9/0407; H01Q 1/14; H01Q 1/48; H01Q 1/50; H01Q 23/00

(57) ABSTRACT

An electronic device may be provided with a phased antenna array with antennas on an antenna module. The module may include a primary substrate and a secondary substrate mounted to the primary substrate by an interconnect. An antenna may include patch elements in the primary substrate and patch elements in the secondary substrate that are fed using conductive vias. Fences of conductive vias may couple the patch elements in the primary substrate to ground to isolate the patch elements in the primary substrate from the patch elements in the secondary substrate. The secondary substrate may be smaller than the primary substrate, allowing the secondary substrate to fit into relatively small portions of the electronic device while locating the patch elements in the secondary substrates closer to free space, thereby maximizing antenna performance.

### BACKGROUND

This relates generally to electronic devices and, more particularly, to electronic devices with wireless communications capabilities.

Electronic devices such as portable computers and cellular telephones are often provided with wireless communications capabilities. To satisfy consumer demand for small form factor wireless devices, manufacturers are continually striving to implement wireless communications circuitry such as antenna components using compact structures. At the same time, there is a desire for antennas to cover as many different frequencies as possible.

It can be challenging to provide antennas that cover wide bandwidths with satisfactory levels of performance while also accommodating the presence of nearby device components.

### SUMMARY

An electronic device may be provided with a housing, a display, and wireless circuitry. The housing may include peripheral conductive housing structures that run around a periphery of the device. The display may include a display cover layer mounted to the peripheral conductive housing structures. The housing may include a rear housing wall opposite the display cover layer. The wireless circuitry may include a phased antenna array that conveys radio-frequency signals at centimeter and/or millimeter wave frequencies. The phased antenna array may be aligned with apertures in the peripheral conductive housing structures or elsewhere in the device.

The phased antenna array may include antennas on an antenna module. The antenna module may include a primary substrate and a secondary substrate mounted to the primary substrate. An interconnect may couple the primary substrate to the secondary substrate. An antenna may include one or more patch elements in the primary substrate and one or more patch elements in the secondary substrate and overlapping the patch elements in the primary substrate. The patch elements in the primary and/or secondary substrates may be fed using conductive vias. A patch element in the secondary substrate may be fed using a conductive via that passes through the patch elements in the primary substrate. Fences of conductive vias may couple the patch elements in the primary substrate to ground around the conductive via feeding the secondary substrate to isolate the patch elements in the primary substrate from the patch elements in the secondary substrate.

Each antenna in the phased antenna array may include a different respective secondary substrate or the antennas may share a single secondary substrate. Electrical components may be embedded in the secondary substrate, may be disposed on the primary substrate between different secondary substrates, and/or may be mounted to the secondary substrates. The secondary substrates may be provided with edge metallizations and/or may be embedded in an encapsulation layer. The secondary substrates may be smaller than the primary substrate, which may allow the secondary substrates to fit into relatively small portions of the electronic device while locating the patch elements in the secondary substrates closer to free space, thereby maximizing antenna performance.

### BRIEF DESCRIPTION OF THE DRAWINGS

FIG. 1 is a perspective view of an illustrative electronic device in accordance with some embodiments.

FIG. 2 is a schematic diagram of illustrative circuitry in an electronic device in accordance with some embodiments.

FIG. 3 is a schematic diagram of illustrative wireless circuitry in accordance with some embodiments.

FIG. 4 is a diagram of an illustrative phased antenna array in accordance with some embodiments.

FIG. 5 is a perspective view of illustrative patch antenna structures in accordance with some embodiments.

FIG. 6 is a perspective view of an illustrative antenna module in accordance with some embodiments.

FIG. 7 is a front view of an illustrative electronic device showing exemplary locations for mounting an antenna module that radiates through peripheral conductive housing structures in accordance with some embodiments.

FIG. 8 is a side view of an illustrative electronic device having peripheral conductive housing structures with apertures that are aligned with antennas in an antenna module in accordance with some embodiments.

FIG. 9 is a cross-sectional top view of an illustrative patch antenna distributed across stacked primary and secondary substrates of an antenna module in accordance with some embodiments.

FIG. 10 is a cross-sectional side view showing how an illustrative patch antenna distributed across primary and secondary substrates of an antenna module may be mounted within an electronic device for radiating through an aperture in peripheral conductive housing structures in accordance with some embodiments.

FIG. 11 is a plot of antenna gain as a function of frequency showing how distributing an illustrative patch antenna across primary and secondary substrates of an antenna module may optimize radio-frequency performance relative to confining the patch antenna to a single substrate in accordance with some embodiments.

FIG. 12 is a top view showing how an illustrative secondary substrate may be nested within a cavity in a primary substrate of an antenna module in accordance with some embodiments.

FIG. 13 is a bottom view of an illustrative antenna module having a rigid primary substrate and one or more secondary substrates for the antennas in a phased antenna array in accordance with some embodiments.

FIG. 14 is a bottom view of an illustrative antenna module having a flexible primary substrate and one or more secondary substrates for the antennas in a phased antenna array in accordance with some embodiments.

FIG. 15 is a bottom view of an illustrative antenna module having a flexible primary substrate for mounting secondary substrates at different orientations in accordance with some embodiments.

FIG. 16 is a cross-sectional bottom view showing how an illustrative antenna module may include secondary substrates provided with an underfill, edge metallization, electrical components, and/or an overmold in accordance with some embodiments.

FIG. 17 is a cross-sectional bottom view showing how an illustrative antenna module may be provided with an overmold for supporting each antenna in a phased antenna array without secondary substrates in accordance with some embodiments.

FIG. 18 is a cross-sectional bottom view showing how electrical components may be mounted over, under, and/or within a secondary substrate of an illustrative antenna module in accordance with some embodiments.

### DETAILED DESCRIPTION

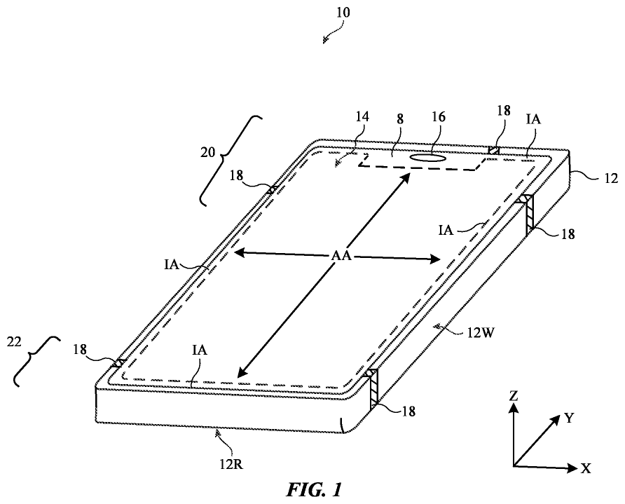

An electronic device such as electronic device 10 of FIG. 1 may be provided with wireless circuitry that includes antennas. The antennas may be used to transmit and/or receive wireless radio-frequency signals. The antennas may include phased antenna arrays that are used for performing wireless communications and/or spatial ranging operations using millimeter and centimeter wave signals. Millimeter wave signals, which are sometimes referred to as extremely high frequency (EHF) signals, propagate at frequencies above about 30 GHz (e.g., at 60 GHz or other frequencies between about 30 GHz and 300 GHz). Centimeter wave signals propagate at frequencies between about 10 GHz and 30 GHz. If desired, device 10 may also contain antennas for handling satellite navigation system signals, cellular telephone signals, local wireless area network signals, near-field communications, light-based wireless communications, or other wireless communications.

Device 10 may be a portable electronic device or other suitable electronic device. For example, device 10 may be a laptop computer, a tablet computer, a somewhat smaller device such as a wrist-watch device, pendant device, headphone device, earpiece device, headset device, or other wearable or miniature device, a handheld device such as a cellular telephone, a media player, or other small portable device. Device 10 may also be a set-top box, a desktop computer, a display into which a computer or other processing circuitry has been integrated, a display without an integrated computer, a wireless access point, a wireless base station, an electronic device incorporated into a kiosk, building, or vehicle, or other suitable electronic equipment.

Device 10 may include a housing such as housing 12. Housing 12, which may sometimes be referred to as a case, may be formed of plastic, glass, ceramics, fiber composites, metal (e.g., stainless steel, aluminum, etc.), other suitable materials, or a combination of these materials. In some situations, parts of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may, if desired, have a display such as display 14. Display 14 may be mounted on the front face of device 10. Display 14 may be a touch screen that incorporates capacitive touch electrodes or may be insensitive to touch. The rear face of housing 12 (i.e., the face of device 10 opposing the front face of device 10) may have a substantially planar housing wall such as rear housing wall 12R (e.g., a planar housing wall). Rear housing wall 12R may have slots that pass entirely through the rear housing wall and that therefore separate portions of housing 12 from each other. Rear housing wall 12R may include conductive portions and/or dielectric portions. If desired, rear housing wall 12R may include a planar metal layer covered by a thin layer or coating of dielectric such as glass, plastic, sapphire, or ceramic (e.g., a dielectric cover layer). Housing 12 may also have shallow grooves that do not pass entirely through housing 12. The slots and grooves may be filled with plastic or other dielectric materials. If desired, portions of housing 12 that have been separated from each other (e.g., by a through slot) may be joined by internal conductive structures (e.g., sheet metal or other metal members that bridge the slot).

Housing 12 may include peripheral housing structures such as peripheral structures 12W. Conductive portions of peripheral structures 12W and conductive portions of rear housing wall 12R may sometimes be referred to herein collectively as conductive structures of housing 12. Peripheral structures 12W may run around the periphery of device 10 and display 14. In configurations in which device 10 and display 14 have a rectangular shape with four edges, peripheral structures 12W may be implemented using peripheral housing structures that have a rectangular ring shape with four corresponding edges and that extend from rear housing wall 12R to the front face of device 10 (as an example). In other words, device 10 may have a length (e.g., measured parallel to the Y-axis), a width that is less than the length (e.g., measured parallel to the X-axis), and a height (e.g., measured parallel to the Z-axis) that is less than the width. Peripheral structures 12W or part of peripheral structures 12W may serve as a bezel for display 14 (e.g., a cosmetic trim that surrounds all four sides of display 14 and/or that helps hold display 14 to device 10) if desired. Peripheral structures 12W may, if desired, form sidewall structures for device 10 (e.g., by forming a metal band with vertical sidewalls, curved sidewalls, etc.).

Peripheral structures 12W may be formed of a conductive material such as metal and may therefore sometimes be referred to as peripheral conductive housing structures, conductive housing structures, peripheral metal structures, peripheral conductive sidewalls, peripheral conductive sidewall structures, conductive housing sidewalls, peripheral conductive housing sidewalls, sidewalls, sidewall structures, or a peripheral conductive housing member (as examples). Peripheral conductive housing structures 12W may be formed from a metal such as stainless steel, aluminum, alloys, or other suitable materials. One, two, or more than two separate structures may be used in forming peripheral conductive housing structures 12W.

It is not necessary for peripheral conductive housing structures 12W to have a uniform cross-section. For example, the top portion of peripheral conductive housing structures 12W may, if desired, have an inwardly protruding ledge that helps hold display 14 in place. The bottom portion of peripheral conductive housing structures 12W may also have an enlarged lip (e.g., in the plane of the rear surface of device 10). Peripheral conductive housing structures 12W may have substantially straight vertical sidewalls, may have sidewalls that are curved, or may have other suitable shapes. In some configurations (e.g., when peripheral conductive housing structures 12W serve as a bezel for display 14), peripheral conductive housing structures 12W may run around the lip of housing 12 (i.e., peripheral conductive housing structures 12W may cover only the edge of housing 12 that surrounds display 14 and not the rest of the sidewalls of housing 12).

Rear housing wall 12R may lie in a plane that is parallel to display 14. In configurations for device 10 in which some or all of rear housing wall 12R is formed from metal, it may be desirable to form parts of peripheral conductive housing structures 12W as integral portions of the housing structures forming rear housing wall 12R. For example, rear housing wall 12R of device 10 may include a planar metal structure and portions of peripheral conductive housing structures 12W on the sides of housing 12 may be formed as flat or curved vertically extending integral metal portions of the planar metal structure (e.g., housing structures 12R and 12W may be formed from a continuous piece of metal in a unibody configuration). Housing structures such as these may, if desired, be machined from a block of metal and/or may include multiple metal pieces that are assembled together to form housing 12. Rear housing wall 12R may have one or more, two or more, or three or more portions. Peripheral conductive housing structures 12W and/or conductive portions of rear housing wall 12R may form one or more exterior surfaces of device 10 (e.g., surfaces that are visible to a user of device 10) and/or may be implemented using internal structures that do not form exterior surfaces of device 10 (e.g., conductive housing structures that are not visible to a user of device 10 such as conductive structures that are covered with layers such as thin cosmetic layers, protective coatings, and/or other coating/cover layers that may include dielectric materials such as glass, ceramic, plastic, or other structures that form the exterior surfaces of device 10 and/or serve to hide peripheral conductive housing structures 12W and/or conductive portions of rear housing wall 12R from view of the user).

Display 14 may have an array of pixels that form an active area AA that displays images for a user of device 10. For example, active area AA may include an array of display pixels. The array of pixels may be formed from liquid crystal display (LCD) components, an array of electrophoretic pixels, an array of plasma display pixels, an array of organic light-emitting diode display pixels or other light-emitting diode pixels, an array of electrowetting display pixels, or display pixels based on other display technologies. If desired, active area AA may include touch sensors such as touch sensor capacitive electrodes, force sensors, or other sensors for gathering a user input.

Display 14 may have an inactive border region that runs along one or more of the edges of active area AA. Inactive area IA of display 14 may be free of pixels for displaying images and may overlap circuitry and other internal device structures in housing 12. To block these structures from view by a user of device 10, the underside of the display cover layer or other layers in display 14 that overlap inactive area IA may be coated with an opaque masking layer in inactive area IA. The opaque masking layer may have any suitable color. Inactive area IA may include a recessed region or notch that extends into active area AA (e.g., at speaker port 16). Active area AA may, for example, be defined by the lateral area of a display module for display 14 (e.g., a display module that includes pixel circuitry, touch sensor circuitry, etc.). The display module may have a recess or notch in upper region 20 of device 10 that is free from active display circuitry (i.e., that forms notch 8 of inactive area IA). Notch 8 may be a substantially rectangular region that is surrounded (defined) on three sides by active area AA and on a fourth side by peripheral conductive housing structures 12W. Alternatively, notch 8 may be surrounded on all sides by active area AA (e.g., notch 8 may be detached from housing 12 and may form an island of inactive area IA surrounded by active area AA). One or more sensors may be aligned with notch 8 and may transmit and/or receive light through display 14 within notch 8.

Display 14 may be protected using a display cover layer such as a layer of transparent glass, clear plastic, transparent ceramic, sapphire, or other transparent crystalline material, or other transparent layer(s). The display cover layer may have a planar shape, a convex curved profile, a shape with planar and curved portions, a layout that includes a planar main area surrounded on one or more edges with a portion that is bent out of the plane of the planar main area, or other suitable shapes. The display cover layer may cover the entire front face of device 10. In another suitable arrangement, the display cover layer may cover substantially all of the front face of device 10 or only a portion of the front face of device 10. Openings may be formed in the display cover layer. For example, an opening may be formed in the display cover layer to accommodate a button. An opening may also be formed in the display cover layer to accommodate ports such as speaker port 16 or a microphone port. Openings may be formed in housing 12 to form communications ports (e.g., an audio jack port, a digital data port, etc.) and/or audio ports for audio components such as a speaker and/or a microphone if desired.

Display 14 may include conductive structures such as an array of capacitive electrodes for a touch sensor, conductive lines for addressing pixels, driver circuits, etc. Housing 12 may include internal conductive structures such as metal frame members and a planar conductive housing member (sometimes referred to as a conductive support plate or backplate) that spans the walls of housing 12 (e.g., a substantially rectangular sheet formed from one or more metal parts that is welded or otherwise connected between opposing sides of peripheral conductive housing structures 12W). The conductive support plate may form an exterior rear surface of device 10 or may be covered by a dielectric cover layer such as a thin cosmetic layer, protective coating, and/or other coatings that may include dielectric materials such as glass, ceramic, plastic, or other structures that form the exterior surfaces of device 10 and/or serve to hide the conductive support plate from view of the user (e.g., the conductive support plate may form part of rear housing wall 12R). Device 10 may also include conductive structures such as printed circuit boards, components mounted on printed circuit boards, and other internal conductive structures. These conductive structures, which may be used in forming a ground plane in device 10, may extend under active area AA of display 14, for example.

In regions 22 and 20, openings may be formed within the conductive structures of device 10 (e.g., between peripheral conductive housing structures 12W and opposing conductive ground structures such as conductive portions of rear housing wall 12R, conductive traces on a printed circuit board, conductive electrical components in display 14, etc.). These openings, which may sometimes be referred to as gaps, may be filled with air, plastic, and/or other dielectrics and may be used in forming slot antenna resonating elements for one or more antennas in device 10, if desired.

Conductive housing structures and other conductive structures in device 10 may serve as a ground plane for the antennas in device 10. The openings in regions 22 and 20 may serve as slots in open or closed slot antennas, may serve as a central dielectric region that is surrounded by a conductive path of materials in a loop antenna, may serve as a space that separates an antenna resonating element such as a strip antenna resonating element or an inverted-F antenna resonating element from the ground plane, may contribute to the performance of a parasitic antenna resonating element, or may otherwise serve as part of antenna structures formed in regions 22 and 20. If desired, the ground plane that is under active area AA of display 14 and/or other metal structures in device 10 may have portions that extend into parts of the ends of device 10 (e.g., the ground may extend towards the dielectric-filled openings in regions 22 and 20), thereby narrowing the slots in regions 22 and 20. Region 22 may sometimes be referred to herein as lower region 22 or lower end 22 of device 10. Region 20 may sometimes be referred to herein as upper region 20 or upper end 20 of device 10.

In general, device 10 may include any suitable number of antennas (e.g., one or more, two or more, three or more, four or more, etc.). The antennas in device 10 may be located at opposing first and second ends of an elongated device housing (e.g., at lower region 22 and/or upper region 20 of device 10 of FIG. 1), along one or more edges of a device housing, in the center of a device housing, in other suitable locations, or in one or more of these locations. The arrangement of FIG. 1 is merely illustrative.

Portions of peripheral conductive housing structures 12W may be provided with peripheral gap structures. For example, peripheral conductive housing structures 12W may be provided with one or more dielectric-filled gaps such as gaps 18, as shown in FIG. 1. The gaps in peripheral conductive housing structures 12W may be filled with dielectric such as polymer, ceramic, glass, air, other dielectric materials, or combinations of these materials. Gaps 18 may divide peripheral conductive housing structures 12W into one or more peripheral conductive segments. The conductive segments that are formed in this way may form parts of antennas in device 10 if desired. Other dielectric openings may be formed in peripheral conductive housing structures 12W (e.g., dielectric openings other than gaps 18) and may serve as dielectric antenna windows for antennas mounted within the interior of device 10. Antennas within device 10 may be aligned with the dielectric antenna windows for conveying radio-frequency signals through peripheral conductive housing structures 12W. Antennas within device 10 may also be aligned with inactive area IA of display 14 for conveying radio-frequency signals through display 14.

To provide an end user of device 10 with as large of a display as possible (e.g., to maximize an area of the device used for displaying media, running applications, etc.), it may be desirable to increase the amount of area at the front face of device 10 that is covered by active area AA of display 14. Increasing the size of active area AA may reduce the size of inactive area IA within device 10. This may reduce the area behind display 14 that is available for antennas within device 10. For example, active area AA of display 14 may include conductive structures that serve to block radio-frequency signals handled by antennas mounted behind active area AA from radiating through the front face of device 10. It would therefore be desirable to be able to provide antennas that occupy a small amount of space within device 10 (e.g., to allow for as large of a display active area AA as possible) while still allowing the antennas to communicate with wireless equipment external to device 10 with satisfactory efficiency bandwidth.

In some implementations, device 10 may have one or more upper antennas and one or more lower antennas. An upper antenna may, for example, be formed in upper region 20 of device 10. A lower antenna may, for example, be formed in lower region 22 of device 10. Additional antennas may be formed along the edges of housing 12 extending between regions 20 and 22 if desired. An example in which device 10 includes three or four upper antennas and five lower antennas is described herein as an example. The antennas may be used separately to cover identical communications bands, overlapping communications bands, or separate communications bands. The antennas may be used to implement an antenna diversity scheme or a multiple-input-multiple-output (MIMO) antenna scheme. Other antennas for covering any other desired frequencies may also be mounted at any desired locations within the interior of device 10. The example of FIG. 1 is merely illustrative. If desired, housing 12 may have other shapes (e.g., a square shape, cylindrical shape, spherical shape, combinations of these and/or different shapes, etc.).

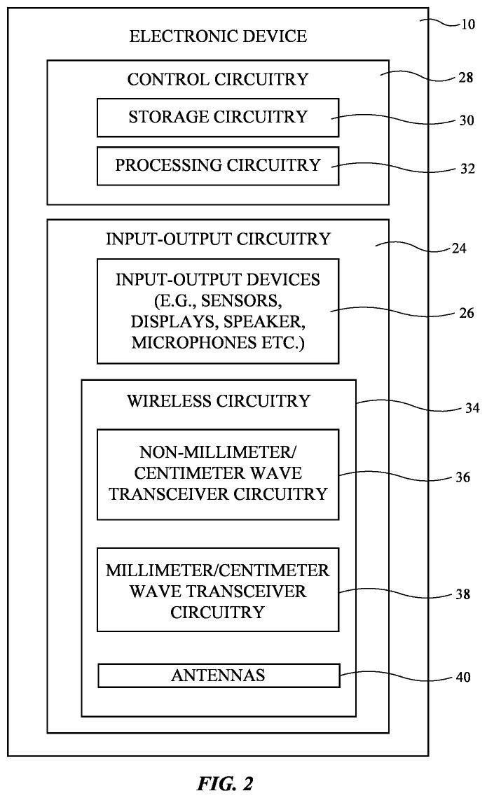

A schematic diagram of illustrative components that may be used in device 10 is shown in FIG. 2. As shown in FIG. 2, device 10 may include control circuitry 28. Control circuitry 28 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc.

Control circuitry 28 may include processing circuitry such as processing circuitry 32. Processing circuitry 32 may be used to control the operation of device 10. Processing circuitry 32 may include one or more processors such as microprocessors, microcontrollers, digital signal processors, host processors, baseband processor integrated circuits, application specific integrated circuits, graphics processing units, central processing units (CPUs), etc. Control circuitry 28 may be configured to perform operations in device 10 using hardware (e.g., dedicated hardware or circuitry), firmware, and/or software. Software code for performing operations in device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 28 may be used to run software on device 10 such as internet browsing applications, voice-over-internet-protocol (VOIP) telephone call applications, email applications, media playback applications, operating system functions, etc. To support interactions with external equipment, control circuitry 28 may be used in implementing communications protocols. Communications protocols that may be implemented using control circuitry 28 include internet protocols, wireless local area network protocols (e.g., IEEE 802.11 protocols-sometimes referred to as WiFi®), protocols for other short-range wireless communications links such as the Bluetooth® protocol or other WPAN protocols, IEEE 802.11ad protocols, cellular telephone protocols, MIMO protocols, antenna diversity protocols, satellite navigation system protocols, antenna-based spatial ranging protocols (e.g., radio detection and ranging (RADAR) protocols or other desired range detection protocols for signals conveyed at millimeter and centimeter wave frequencies), etc. Each communication protocol may be associated with a corresponding radio access technology (RAT) that specifies the physical connection methodology used in implementing the protocol.

Device 10 may include input-output circuitry 24. Input-output circuitry 24 may include input-output devices 26. Input-output devices 26 may be used to allow data to be supplied to device 10 and to allow data to be provided from device 10 to external devices. Input-output devices 26 may include user interface devices, data port devices, sensors, and other input-output components. For example, input-output devices may include touch screens, displays without touch sensor capabilities, buttons, joysticks, scrolling wheels, touch pads, key pads, keyboards, microphones, cameras, speakers, status indicators, light sources, audio jacks and other audio port components, digital data port devices, light sensors, gyroscopes, accelerometers or other components that can detect motion and device orientation relative to the Earth, capacitance sensors, proximity sensors (e.g., a capacitive proximity sensor and/or an infrared proximity sensor), magnetic sensors, and other sensors and input-output components.

Input-output circuitry 24 may include wireless circuitry such as wireless circuitry 34 for wirelessly conveying radio-frequency signals. While control circuitry 28 is shown separately from wireless circuitry 34 in the example of FIG. 2 for the sake of clarity, wireless circuitry 34 may include processing circuitry that forms a part of processing circuitry 32 and/or storage circuitry that forms a part of storage circuitry 30 of control circuitry 28 (e.g., portions of control circuitry 28 may be implemented on wireless circuitry 34). As an example, control circuitry 28 may include baseband processor circuitry or other control components that form a part of wireless circuitry 34.

Wireless circuitry 34 may include millimeter and centimeter wave transceiver circuitry such as millimeter/centimeter wave transceiver circuitry 38. Millimeter/centimeter wave transceiver circuitry 38 may support communications at frequencies between about 10 GHz and 300 GHz. For example, millimeter/centimeter wave transceiver circuitry 38 may support communications in Extremely High Frequency (EHF) or millimeter wave communications bands between about 30 GHz and 300 GHz and/or in centimeter wave communications bands between about 10 GHz and 30 GHZ (sometimes referred to as Super High Frequency (SHF) bands). As examples, millimeter/centimeter wave transceiver circuitry 38 may support communications in an IEEE K communications band between about 18 GHZ and 27 GHZ, a Kₐ communications band between about 26.5 GHz and 40 GHz, a Kₐ communications band between about 12 GHZ and 18 GHz, a V communications band between about 40 GHz and 75 GHZ, a W communications band between about 75 GHz and 110 GHz, or any other desired frequency band between approximately 10 GHz and 300 GHz. If desired, millimeter/centimeter wave transceiver circuitry 38 may support IEEE 802.11ad communications at 60 GHZ (e.g., WiGig or 60 GHz Wi-Fi bands around 57-61 GHZ), and/or 5^{th} generation mobile networks or 5^{th} generation wireless systems (5G) New Radio (NR) Frequency Range 2 (FR2) communications bands between about 24 GHz and 90 GHz. Millimeter/centimeter wave transceiver circuitry 38 may be formed from one or more integrated circuits (e.g., multiple integrated circuits mounted on a common printed circuit in a system-in-package device, one or more integrated circuits mounted on different substrates, etc.).

If desired, millimeter/centimeter wave transceiver circuitry 38 (sometimes referred to herein simply as transceiver circuitry 38 or millimeter/centimeter wave circuitry 38) may perform spatial ranging operations using radio-frequency signals at millimeter and/or centimeter wave frequencies that are transmitted and received by millimeter/centimeter wave transceiver circuitry 38. The received signals may be a version of the transmitted signals that have been reflected off of external objects and back towards device 10. Control circuitry 28 may process the transmitted and received signals to detect or estimate a range between device 10 and one or more external objects in the surroundings of device 10 (e.g., objects external to device 10 such as the body of a user or other persons, other devices, animals, furniture, walls, or other objects or obstacles in the vicinity of device 10). If desired, control circuitry 28 may also process the transmitted and received signals to identify a two or three-dimensional spatial location of the external objects relative to device 10.

Spatial ranging operations performed by millimeter/centimeter wave transceiver circuitry 38 are unidirectional. If desired, millimeter/centimeter wave transceiver circuitry 38 may also perform bidirectional communications with external wireless equipment such as external wireless equipment 10 (e.g., over a bi-directional millimeter/centimeter wave wireless communications link). The external wireless equipment may include other electronic devices such as electronic device 10, a wireless base station, wireless access point, a wireless accessory, or any other desired equipment that transmits and receives millimeter/centimeter wave signals. Bidirectional communications involve both the transmission of wireless data by millimeter/centimeter wave transceiver circuitry 38 and the reception of wireless data that has been transmitted by external wireless equipment. The wireless data may, for example, include data that has been encoded into corresponding data packets such as wireless data associated with a telephone call, streaming media content, internet browsing, wireless data associated with software applications running on device 10, email messages, etc.

If desired, wireless circuitry 34 may include transceiver circuitry for handling communications at frequencies below 10 GHz such as non-millimeter/centimeter wave transceiver circuitry 36. For example, non-millimeter/centimeter wave transceiver circuitry 36 may handle wireless local area network (WLAN) frequency bands (e.g., Wi-Fi® (IEEE 802.11) or other WLAN communications bands) such as a 2.4 GHZ WLAN band (e.g., from 2400 to 2480 MHZ), a 5 GHZ WLAN band (e.g., from 5180 to 5825 MHz), a Wi-Fi® 6E band (e.g., from 5925-7125 MHZ), and/or other Wi-Fi® bands (e.g., from 1875-5160 MHZ), wireless personal area network (WPAN) frequency bands such as the 2.4 GHz Bluetooth® band or other WPAN communications bands, cellular telephone frequency bands (e.g., bands from about 600 MHz to about 5 GHZ, 3G bands, 4G LTE bands, 5G New Radio Frequency Range 1 (FR1) bands below 10 GHz, etc.), near-field communications frequency bands (e.g., at 13.56 MHZ), satellite navigation frequency bands such as the Global Positioning System (GPS) L1 band (e.g., at 1575 MHz), L2 band (e.g., at 1228 MHZ), L3 band (e.g., at 1381 MHZ), L4 band (e.g., at 1380 MHz), and/or L5 band (e.g., at 1176 MHZ), a Global Navigation Satellite System (GLONASS) band, or a BeiDou Navigation Satellite System (BDS) band, ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, satellite communications bands such as an L-band, S-band (e.g., from 2-4 GHZ), C-band (e.g., from 4-8 GHZ), X-band, Ku-band (e.g., from 12-18 GHZ), Ka-band (e.g., from 26-40 GHz), etc., industrial, scientific, and medical (ISM) bands such as an ISM band between around 900 MHz and 950 MHz or other ISM bands below or above 1 GHz, one or more unlicensed bands, one or more bands reserved for emergency and/or public services, and/or any other desired frequency bands of interest. The communications bands handled by the radio-frequency transceiver circuitry may sometimes be referred to herein as frequency bands or simply as “bands,” and may span corresponding ranges of frequencies. Non-millimeter/centimeter wave transceiver circuitry 36 and millimeter/centimeter wave transceiver circuitry 38 may each include one or more integrated circuits, power amplifier circuitry, low-noise input amplifiers, passive radio-frequency components, switching circuitry, transmission line structures, and other circuitry for handling radio-frequency signals.

If desired, non-millimeter/centimeter wave transceiver circuitry 36 and millimeter/centimeter wave transceiver circuitry 38 may be integrated into a single transceiver for handling any desired bands. Radio-frequency transceiver circuitry in wireless circuitry 34 may include respective transceivers (e.g., transceiver integrated circuits or chips) that handle different frequency bands or any desired number of transceivers that handle two or more frequency bands. In scenarios where different transceivers are coupled to the same antenna, filter circuitry (e.g., duplexer circuitry, diplexer circuitry, low pass filter circuitry, high pass filter circuitry, band pass filter circuitry, band stop filter circuitry, etc.), switching circuitry, multiplexing circuitry, or any other desired circuitry may be used to isolate radio-frequency signals conveyed by each transceiver over the same antenna (e.g., filtering circuitry or multiplexing circuitry may be interposed on a radio-frequency transmission line shared by the transceivers). The radio-frequency transceiver circuitry may include one or more integrated circuits (chips), integrated circuit packages (e.g., multiple integrated circuits mounted on a common printed circuit in a system-in-package device, one or more integrated circuits mounted on different substrates, etc.), power amplifier circuitry, up-conversion circuitry, down-conversion circuitry, low-noise input amplifiers, passive radio-frequency components, switching circuitry, transmission line structures, and other circuitry for handling radio-frequency signals and/or for converting signals between radio-frequencies, intermediate frequencies, and/or baseband frequencies.

As shown in FIG. 2, wireless circuitry 34 may include antennas 40. The transceiver circuitry may convey radio-frequency signals using one or more antennas 40 (e.g., antennas 40 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antennas 40 may transmit the radio-frequency signals by radiating the radio-frequency signals into free space (or to freespace through intervening device structures such as a dielectric cover layer). Antennas 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

In satellite navigation system links, cellular telephone links, and other long-range links, radio-frequency signals are typically used to convey data over thousands of feet or miles. In Wi-Fi® and Bluetooth® links at 2.4 and 5 GHZ and other short-range wireless links, radio-frequency signals are typically used to convey data over tens or hundreds of feet. Millimeter/centimeter wave transceiver circuitry 38 may convey radio-frequency signals over short distances that travel over a line-of-sight path. To enhance signal reception for millimeter and centimeter wave communications, phased antenna arrays and beam forming (steering) techniques may be used (e.g., schemes in which antenna signal phase and/or magnitude for each antenna in an array are adjusted to perform beam steering). Antenna diversity schemes may also be used to ensure that the antennas that have become blocked or that are otherwise degraded due to the operating environment of device 10 can be switched out of use and higher-performing antennas used in their place.

Antennas 40 in wireless circuitry 34 may be formed using any suitable antenna types. For example, antennas 40 may include antennas with resonating elements that are formed from stacked patch antenna structures, loop antenna structures, patch antenna structures, inverted-F antenna structures, slot antenna structures, planar inverted-F antenna structures, monopole antenna structures, dipole antenna structures, helical antenna structures, Yagi (Yagi-Uda) antenna structures, hybrids of these designs, etc. In another suitable arrangement, antennas 40 may include antennas with dielectric resonating elements such as dielectric resonator antennas. If desired, one or more of antennas 40 may be cavity-backed antennas. Different types of antennas may be used for different bands and combinations of bands. For example, one type of antenna may be used in forming a non-millimeter/centimeter wave wireless link for non-millimeter/centimeter wave transceiver circuitry 36 and another type of antenna may be used in conveying radio-frequency signals at millimeter and/or centimeter wave frequencies for millimeter/centimeter wave transceiver circuitry 38. Antennas 40 that are used to convey radio-frequency signals at millimeter and centimeter wave frequencies may be arranged in one or more phased antenna arrays.

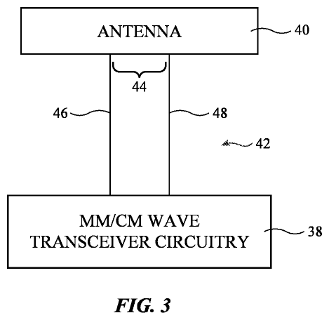

A schematic diagram of an antenna 40 that may be formed in a phased antenna array for conveying radio-frequency signals at millimeter and centimeter wave frequencies is shown in FIG. 3. As shown in FIG. 3, antenna 40 may be coupled to millimeter/centimeter (MM/CM) wave transceiver circuitry 38. Millimeter/centimeter wave transceiver circuitry 38 may be coupled to antenna feed 44 of antenna 40 using a transmission line path that includes radio-frequency transmission line 42. Radio-frequency transmission line 42 may include a positive signal conductor such as signal conductor 46 and may include a ground conductor such as ground conductor 48. Ground conductor 48 may be coupled to the antenna ground for antenna 40 (e.g., over a ground antenna feed terminal of antenna feed 44 located at the antenna ground). Signal conductor 46 may be coupled to the antenna resonating element for antenna 40. For example, signal conductor 46 may be coupled to a positive antenna feed terminal of antenna feed 44 located at the antenna resonating element.

Radio-frequency transmission line 42 may include a stripline transmission line (sometimes referred to herein simply as a stripline), a coaxial cable, a coaxial probe realized by metalized vias, a microstrip transmission line, an edge-coupled microstrip transmission line, an edge-coupled stripline transmission lines, a waveguide structure, combinations of these, etc. Multiple types of transmission lines may be used to form the transmission line path that couples millimeter/centimeter wave transceiver circuitry 38 to antenna feed 44. Filter circuitry, switching circuitry, impedance matching circuitry, phase shifter circuitry, amplifier circuitry, and/or other circuitry may be interposed on radio-frequency transmission line 42, if desired.

Radio-frequency transmission lines in device 10 may be integrated into ceramic substrates, rigid printed circuit boards, and/or flexible printed circuits. In one suitable arrangement, radio-frequency transmission lines in device 10 may be integrated within multilayer laminated structures (e.g., layers of a conductive material such as copper and a dielectric material such as a resin that are laminated together without intervening adhesive) that may be folded or bent in multiple dimensions (e.g., two or three dimensions) and that maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

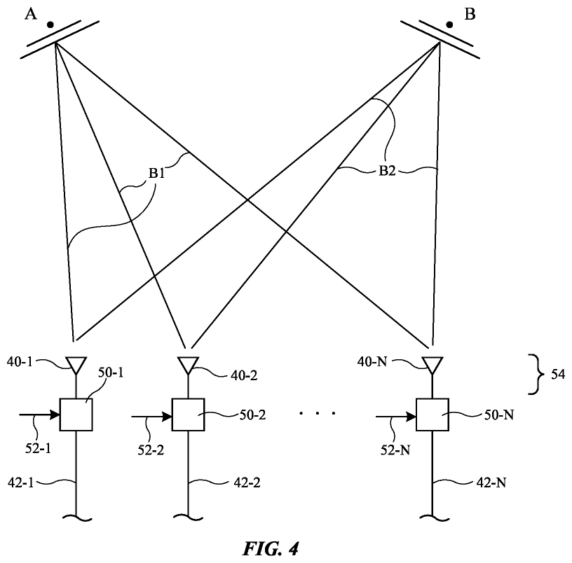

FIG. 4 shows how antennas 40 for handling radio-frequency signals at millimeter and centimeter wave frequencies may be formed in a phased antenna array. As shown in FIG. 4, phased antenna array 54 (sometimes referred to herein as array 54, antenna array 54, or array 54 of antennas 40) may be coupled to radio-frequency transmission lines 42. For example, a first antenna 40-1 in phased antenna array 54 may be coupled to a first radio-frequency transmission line 42-1, a second antenna 40-2 in phased antenna array 54 may be coupled to a second radio-frequency transmission line 42-2, an Nth antenna 40-N in phased antenna array 54 may be coupled to an Nth radio-frequency transmission line 42-N, etc. While antennas 40 are described herein as forming a phased antenna array, the antennas 40 in phased antenna array 54 may sometimes also be referred to as collectively forming a single phased array antenna.

Antennas 40 in phased antenna array 54 may be arranged in any desired number of rows and columns or in any other desired pattern (e.g., the antennas need not be arranged in a grid pattern having rows and columns). During signal transmission operations, radio-frequency transmission lines 42 may be used to supply signals (e.g., radio-frequency signals such as millimeter wave and/or centimeter wave signals) from millimeter/centimeter wave transceiver circuitry 38 (FIG. 3) to phased antenna array 54 for wireless transmission. During signal reception operations, radio-frequency transmission lines 42 may be used to supply signals received at phased antenna array 54 (e.g., from external wireless equipment or transmitted signals that have been reflected off of external objects) to millimeter/centimeter wave transceiver circuitry 38 (FIG. 3).

The use of multiple antennas 40 in phased antenna array 54 allows beam steering arrangements to be implemented by controlling the relative phases and magnitudes (amplitudes) of the radio-frequency signals conveyed by the antennas. In the example of FIG. 4, antennas 40 each have a corresponding radio-frequency phase and magnitude controller 50 (e.g., a first phase and magnitude controller 50-1 interposed on radio-frequency transmission line 42-1 may control phase and magnitude for radio-frequency signals handled by antenna 40-1, a second phase and magnitude controller 50-2 interposed on radio-frequency transmission line 42-2 may control phase and magnitude for radio-frequency signals handled by antenna 40-2, an Nth phase and magnitude controller 50-N interposed on radio-frequency transmission line 42-N may control phase and magnitude for radio-frequency signals handled by antenna 40-N, etc.).

Phase and magnitude controllers 50 may each include circuitry for adjusting the phase of the radio-frequency signals on radio-frequency transmission lines 42 (e.g., phase shifter circuits) and/or circuitry for adjusting the magnitude of the radio-frequency signals on radio-frequency transmission lines 42 (e.g., power amplifier and/or low noise amplifier circuits). Phase and magnitude controllers 50 may sometimes be referred to collectively herein as beam steering circuitry (e.g., beam steering circuitry that steers the beam of radio-frequency signals transmitted and/or received by phased antenna array 54).

Phase and magnitude controllers 50 may adjust the relative phases and/or magnitudes of the transmitted signals that are provided to each of the antennas in phased antenna array 54 and may adjust the relative phases and/or magnitudes of the received signals that are received by phased antenna array 54. Phase and magnitude controllers 50 may, if desired, include phase detection circuitry for detecting the phases of the received signals that are received by phased antenna array 54. The term “beam” or “signal beam” may be used herein to collectively refer to wireless signals that are transmitted and received by phased antenna array 54 in a particular direction. The signal beam may exhibit a peak gain that is oriented in a particular pointing direction at a corresponding pointing angle (e.g., based on constructive and destructive interference from the combination of signals from each antenna in the phased antenna array). The term “transmit beam” may sometimes be used herein to refer to radio-frequency signals that are transmitted in a particular direction whereas the term “receive beam” may sometimes be used herein to refer to radio-frequency signals that are received from a particular direction. If, for example, phase and magnitude controllers 50 are adjusted to produce a first set of phases and/or magnitudes for transmitted radio-frequency signals, the transmitted signals will form a transmit beam as shown by beam B1 of FIG. 4 that is oriented in the direction of point A. If, however, phase and magnitude controllers 50 are adjusted to produce a second set of phases and/or magnitudes for the transmitted signals, the transmitted signals will form a transmit beam as shown by beam B2 that is oriented in the direction of point B. Similarly, if phase and magnitude controllers 50 are adjusted to produce the first set of phases and/or magnitudes, radio-frequency signals (e.g., radio-frequency signals in a receive beam) may be received from the direction of point A, as shown by beam B1. If phase and magnitude controllers 50 are adjusted to produce the second set of phases and/or magnitudes, radio-frequency signals may be received from the direction of point B, as shown by beam B2.

Each phase and magnitude controller 50 may be controlled to produce a desired phase and/or magnitude based on a corresponding control signal 52 received from control circuitry 28 of FIG. 2 (e.g., the phase and/or magnitude provided by phase and magnitude controller 50-1 may be controlled using control signal 52-1, the phase and/or magnitude provided by phase and magnitude controller 50-2 may be controlled using control signal 52-2, etc.). If desired, the control circuitry may actively adjust control signals 52 in real time to steer the transmit or receive beam in different desired directions over time. Phase and magnitude controllers 50 may provide information identifying the phase of received signals to control circuitry 28 if desired.

When performing wireless communications using radio-frequency signals at millimeter and centimeter wave frequencies, the radio-frequency signals are conveyed over a line of sight path between phased antenna array 54 and external communications equipment. If the external object is located at point A of FIG. 4, phase and magnitude controllers 50 may be adjusted to steer the signal beam towards point A (e.g., to steer the pointing direction of the signal beam towards point A). Phased antenna array 54 may transmit and receive radio-frequency signals in the direction of point A. Similarly, if the external communications equipment is located at point B, phase and magnitude controllers 50 may be adjusted to steer the signal beam towards point B (e.g., to steer the pointing direction of the signal beam towards point B). Phased antenna array 54 may transmit and receive radio-frequency signals in the direction of point B. In the example of FIG. 4, beam steering is shown as being performed over a single degree of freedom for the sake of simplicity (e.g., towards the left and right on the page of FIG. 4). However, in practice, the beam may be steered over two or more degrees of freedom (e.g., in three dimensions, into and out of the page and to the left and right on the page of FIG. 4). Phased antenna array 54 may have a corresponding field of view over which beam steering can be performed (e.g., in a hemisphere or a segment of a hemisphere over the phased antenna array). If desired, device 10 may include multiple phased antenna arrays that each face a different direction to provide coverage from multiple sides of the device.

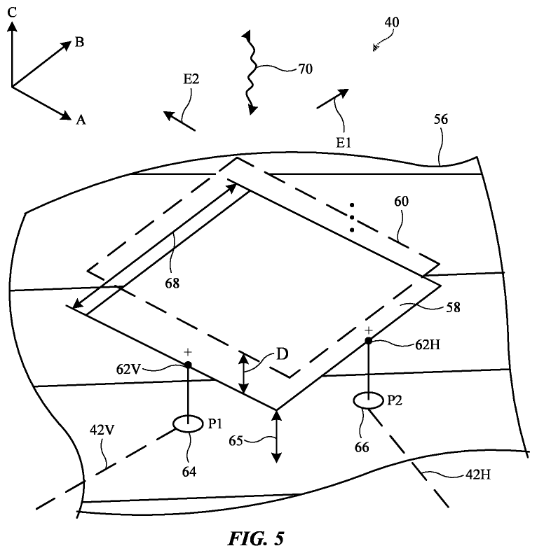

Any desired antenna structures may be used for implementing antennas 40. In one suitable arrangement that is sometimes described herein as an example, patch antenna structures may be used for implementing antennas 40. Antennas 40 that are implemented using patch antenna structures may sometimes be referred to herein as patch antennas. An illustrative patch antenna that may be used in phased antenna array 54 of FIG. 4 is shown in FIG. 5.

As shown in FIG. 5, antenna 40 may have a patch antenna resonating element 58 that is separated from and parallel to a ground plane such as antenna ground 56. Patch antenna resonating element 58 may lie within a plane such as the A-B plane of FIG. 5 (e.g., the lateral surface area of element 58 may lie in the A-B plane). Patch antenna resonating element 58 may sometimes be referred to herein as patch 58, patch element 58, patch resonating element 58, antenna resonating element 58, or resonating element 58. Antenna ground 56 may lie within a plane that is parallel to the plane of patch element 58. Patch element 58 and antenna ground 56 may therefore lie in separate parallel planes that are separated by distance 65. Patch element 58 and antenna ground 56 may be formed from conductive traces patterned on a dielectric substrate such as a rigid or flexible printed circuit board substrate or any other desired conductive structures.

The length of the sides of patch element 58 may be selected so that antenna 40 resonates at a desired operating frequency. For example, the sides of patch element 58 may each have a length 68 that is approximately equal to half of the wavelength of the signals conveyed by antenna 40 (e.g., the effective wavelength given the dielectric properties of the materials surrounding patch element 58). In one suitable arrangement, length 68 may be between 0.8 mm and 1.2 mm (e.g., approximately 1.1 mm) for covering a millimeter wave frequency band between 57 GHz and 70 GHz or between 1.6 mm and 2.2 mm (e.g., approximately 1.85 mm) for covering a millimeter wave frequency band between 37 GHz and 41 GHz, as just two examples.

The example of FIG. 5 is merely illustrative. Patch element 58 may have a square shape in which all of the sides of patch element 58 are the same length or may have a different rectangular shape. Patch element 58 may be formed in other shapes having any desired number of straight and/or curved edges.

To enhance the polarizations handled by antenna 40, antenna 40 may be provided with multiple feeds. As shown in FIG. 5, antenna 40 may have a first feed at antenna port P1 that is coupled to a first radio-frequency transmission line 42 such as radio-frequency transmission line 42V. Antenna 40 may have a second feed at antenna port P2 that is coupled to a second radio-frequency transmission line 42 such as radio-frequency transmission line 42H. The first antenna feed may have a first ground feed terminal coupled to antenna ground 56 (not shown in FIG. 5 for the sake of clarity) and a first positive antenna feed terminal 62V coupled to patch element 58. The second antenna feed may have a second ground feed terminal coupled to antenna ground 56 (not shown in FIG. 5 for the sake of clarity) and a second positive antenna feed terminal 62H on patch element 58.

Holes or openings such as openings 64 and 66 may be formed in antenna ground 56.

Radio-frequency transmission line 42V may include a vertical conductor (e.g., a conductive through-via, conductive pin, metal pillar, solder bump, combinations of these, or other vertical conductive interconnect structures) that extends through opening 64 to positive antenna feed terminal 62V on patch element 58. Radio-frequency transmission line 42H may include a vertical conductor that extends through opening 66 to positive antenna feed terminal 62H on patch element 58. This example is merely illustrative and, if desired, other transmission line structures may be used (e.g., coaxial cable structures, stripline transmission line structures, etc.).

When using the first antenna feed associated with port P1, antenna 40 may transmit and/or receive radio-frequency signals having a first polarization (e.g., the electric field E1 of radio-frequency signals 70 associated with port P1 may be oriented parallel to the B-axis in FIG. 5). When using the antenna feed associated with port P2, antenna 40 may transmit and/or receive radio-frequency signals having a second polarization (e.g., the electric field E2 of radio-frequency signals 70 associated with port P2 may be oriented parallel to the A-axis of FIG. 5 so that the polarizations associated with ports P1 and P2 are orthogonal to each other).

One of ports P1 and P2 may be used at a given time so that antenna 40 operates as a single-polarization antenna or both ports may be operated at the same time so that antenna 40 operates with other polarizations (e.g., as a dual-polarization antenna, a circularly-polarized antenna, an elliptically-polarized antenna, etc.). If desired, the active port may be changed over time so that antenna 40 can switch between covering vertical or horizontal polarizations at a given time. Ports P1 and P2 may be coupled to different phase and magnitude controllers 50 (FIG. 3) or may both be coupled to the same phase and magnitude controller 50. If desired, ports P1 and P2 may both be operated with the same phase and magnitude at a given time (e.g., when antenna 40 acts as a dual-polarization antenna). If desired, the phases and magnitudes of radio-frequency signals conveyed over ports P1 and P2 may be controlled separately and varied over time so that antenna 40 exhibits other polarizations (e.g., circular or elliptical polarizations).

If care is not taken, antennas 40 such as dual-polarization patch antennas of the type shown in FIG. 5 may have insufficient bandwidth for covering relatively wide ranges of frequencies. It may be desirable for antenna 40 to be able to cover a first frequency band, a second frequency band at frequencies higher than the first frequency band, and a third frequency higher than the second frequency band. In one suitable arrangement that is described herein as an example, the first frequency band may include frequencies from about 24.5-29.5 GHZ (sometimes referred to herein as a low band), the second frequency band may include frequencies from about 37-43.5 GHz (sometimes referred to herein as a midband), and the third frequency band may include frequencies from about 47-48 GHZ (sometimes referred to herein as a high band). In these scenarios, a single patch element 58 may not exhibit sufficient bandwidth on its own to cover an entirety of the first, second, and third frequency bands.

While only a single patch element 58 is shown in FIG. 5 for the sake of clarity, antenna 40 may include multiple patch elements 58 that are vertically stacked and overlapping each other (e.g., along the +C direction). Each patch element 58 may be directly fed using respective antenna feeds and may be coupled to one or two corresponding positive antenna feed terminals 62. Each patch element 58 may have different dimensions or a different size to cover different frequency bands for antenna 40. Additionally or alternatively, antenna 40 may include one or more additional patch elements 60 that are stacked over one or more patch elements 58.

Patch element 60 is unfed (e.g., there are no antenna feed terminals on patch elements 60). As such, patch element 60 is a parasitic patch. Patch element 60 may therefore sometimes be referred to herein as parasitic patch element 60, parasitic patch 60, or parasitic 60. Parasitic patch 60 may partially or completely overlap an underlying patch element 58. If desired, multiple stacked parasitic patches 60 may be provided over an underlying patch element 58 and may be excited by the underlying patch element 58. A lower-most parasitic patch 60 may be separated from a corresponding patch element 58 by distance D, which is selected to provide antenna 40 with a desired bandwidth without occupying excessive volume within device 10. Parasitic patch 60 may be indirectly fed or excited by the underlying directly fed patch element 58. Parasitic patch 60 may have sides with lengths other than length 68, which configure the parasitic patch to radiate at different frequencies than the underlying patch element 58, thereby extending the overall bandwidth of antenna 40.

The combined resonances of each patch element 58 and each parasitic patch 60 in antenna 40 may configure antenna 40 to radiate with satisfactory antenna efficiency across an entirety of the first, second, and third frequency bands (e.g., from 24.5-29.5 GHZ, from 37-43.5 GHz, and from 47-48 GHZ). The example of FIG. 5 is merely illustrative. Parasitic patches 60 may be omitted if desired. Parasitic patches 60 may be rectangular, square, cross-shaped, or any other desired shape having any desired number of straight and/or curved edges. Parasitic patch 60 may be provided at any desired orientation relative to its underlying patch element 58. Antenna 40 may have any desired number of feeds. Other antenna types may be used if desired (e.g., dipole antennas, monopole antennas, slot antennas, etc.).

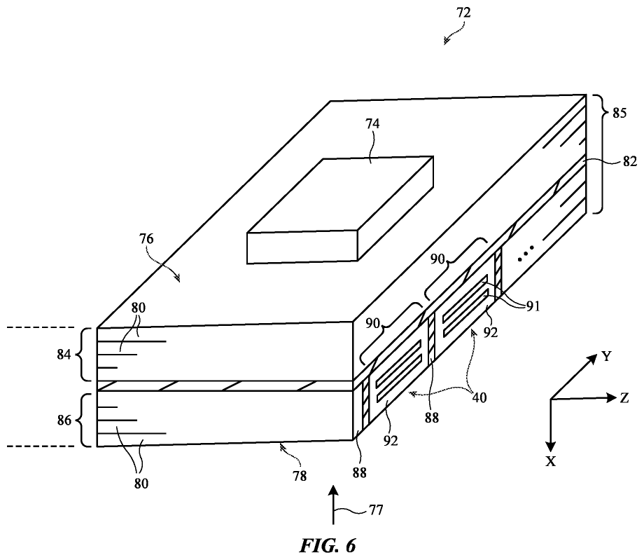

If desired, phased antenna array 54 may be integrated with other circuitry such as a radio-frequency integrated circuit to form an integrated antenna module. FIG. 6 is a rear perspective view showing one example of integrated antenna module for handling signals at frequencies greater than 10 GHz in device 10. As shown in FIG. 6, device 10 may be provided with an integrated antenna module such as integrated antenna module 72 (sometimes referred to herein as antenna module 72 or module 72).

Antenna module 72 may include phased antenna array 54 of antennas 40 formed on a dielectric substrate such as substrate 85. Substrate 85 may be, for example, a rigid printed circuit board, a flexible printed circuit board, a plastic substrate (e.g., a molded substrate), a polymer substrate, an interposer (e.g., a glass or silicon interposer), or another type of substrate. If desired, substrate 85 may be a stacked dielectric substrate that includes multiple stacked dielectric layers 80 (e.g., multiple layers of printed circuit board substrate such as multiple layers of fiberglass-filled epoxy, polymer, silicon, rigid printed circuit board material, ceramic, polyimide, flexible printed circuit board material, plastic, glass, or other dielectrics). Phased antenna array 54 may include any desired number of antennas 40 arranged in any desired pattern.

Antennas 40 in phased antenna array 54 may include antenna elements such as patch elements 91 (e.g., patch elements 91 may form patch element 58 and/or one or more parasitic patches 60 of FIG. 5). Ground traces 82 may be patterned onto substrate 85 (e.g., conductive traces forming antenna ground 56 of FIG. 5 for each of the antennas 40 in phased antenna array 54). Patch elements 91 may be patterned on (bottom) surface 78 of substrate 85 or may be embedded within dielectric layers 80 at or adjacent to surface 78. Only two patch elements 91 are shown in FIG. 6 for the sake of clarity. This is merely illustrative and, in general, antennas 40 may include any desired number of patch elements 91.

One or more electrical components 74 may be mounted on (top) surface 76 of substrate 85 (e.g., the surface of substrate 85 opposite surface 78 and patch elements 91). Component 74 may, for example, include an integrated circuit (e.g., an integrated circuit chip) or other circuitry mounted to surface 76 of substrate 85. Component 74 may include radio-frequency components such as amplifier circuitry, phase shifter circuitry (e.g., phase and magnitude controllers 50 of FIG. 4), and/or other circuitry that operates on radio-frequency signals. Component 74 may sometimes be referred to herein as radio-frequency integrated circuit (RFIC) 74. However, this is merely illustrative and, in general, the circuitry of RFIC 74 need not be formed on an integrated circuit. Component 74 may be embedded within a plastic overmold if desired.

The dielectric layers 80 in substrate 85 may include a first set of layers 86 (sometimes referred to herein as antenna layers 86) and a second set of layers 84 (sometimes referred to herein as transmission line layers 84). Ground traces 82 may separate antenna layers 86 from transmission line layers 84. Conductive traces or other metal layers on transmission line layers 84 may be used in forming transmission line structures such as radio-frequency transmission lines 42 of FIG. 4 (e.g., radio-frequency transmission lines 42V and 42H of FIG. 5). For example, conductive traces on transmission line layers 84 may be used in forming stripline or microstrip transmission lines that are coupled between the antenna feeds for antennas 40 (e.g., over conductive vias extending through antenna layers 86) and RFIC 74 (e.g., over conductive vias extending through transmission line layers 84). A board-to-board connector (not shown) may couple RFIC 74 to the baseband and/or transceiver circuitry for phased antenna array 54 (e.g., millimeter/centimeter wave transceiver circuitry 38 of FIG. 3).

If desired, each antenna 40 in phased antenna array 54 may be laterally surrounded by fences of conductive vias 88 (e.g., conductive vias extending parallel to the X-axis and through antenna layers 86 of FIG. 6). The fences of conductive vias 88 for phased antenna array 54 may be shorted to ground traces 82 so that the fences of conductive vias 88 are held at a ground potential. Conductive vias 88 may extend downwards to surface 78 or to the same dielectric layer 80 as the bottom-most conductive patch 91 in phased antenna array 54.

The fences of conductive vias 88 may be opaque at the frequencies covered by antennas 40. Each antenna 40 may lie within a respective antenna cavity 92 having conductive cavity walls defined by a corresponding set of fences of conductive vias 88 in antenna layers 86. The fences of conductive vias 88 may help to ensure that each antenna 40 in phased antenna array 54 is suitably isolated, for example. Phased antenna array 54 may include a number of antenna unit cells 90. Each antenna unit cell 90 may include respective fences of conductive vias 88, a respective antenna cavity 92 defined by (e.g., laterally surrounded by) those fences of conductive vias, and a respective antenna 40 (e.g., set of patch elements 91) within that antenna cavity 92. Conductive vias 88 may be omitted if desired.

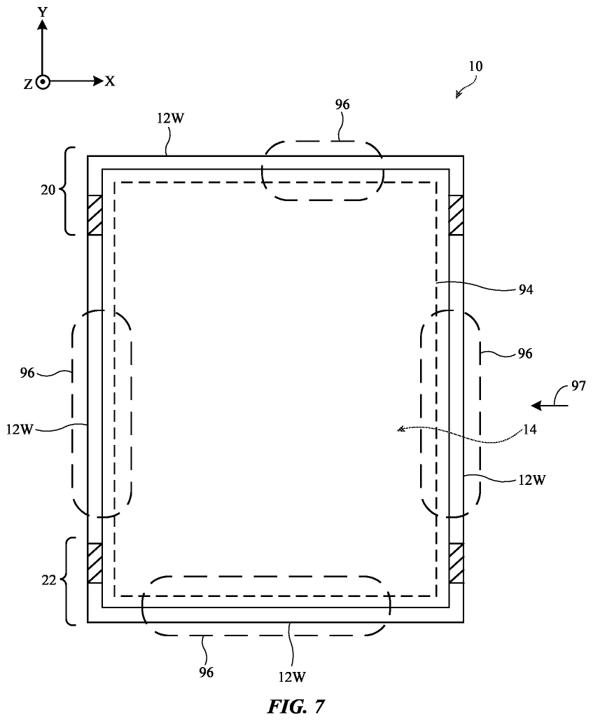

If desired, the antennas on antenna module 72 may radiate through peripheral conductive housing structures 12W (FIG. 1). FIG. 7 is a top view of device 10 showing different illustrative locations for positioning antenna module 72 to convey radio-frequency signals through peripheral conductive housing structures 12W of device 10. As shown in FIG. 7, device 10 may include peripheral conductive housing structures 12W (e.g., four peripheral conductive housing sidewalls that surround the rectangular periphery of device 10). In other words, device 10 may have a length (parallel to the Y-axis), a width that is less than the length (parallel to the X-axis), and a height that is less than the width (parallel to the Z-axis). Peripheral conductive housing structures 12W may extend across the length and the width of device 10 (e.g., peripheral conductive housing structures 12W may include a first conductive sidewall extending along the left edge of device 10, a second conductive sidewall extending along the top edge of device 10, a third conductive sidewall extending along the right edge of device 10, and a fourth conductive sidewall extending along the bottom edge of device 10). Peripheral conductive housing structures 12W may also extend across the height of device 10 (e.g., as shown in the perspective view of FIG. 1).

As shown in FIG. 7, display 14 may have a display module such as display module 94. Peripheral conductive housing structures 12W may run around the periphery of display module 94 (e.g., along all four sides of device 10). Display module 94 may be covered by a display cover layer (not shown). The display cover layer may extend across the entire length and width of device 10 and may, if desired, be mounted to or otherwise supported by peripheral conductive housing structures 12W.

Display module 94 (sometimes referred to as a display panel, active display circuitry, or active display structures) may be any desired type of display panel and may include pixels formed from light-emitting diodes (LEDs), organic LEDs (OLEDs), plasma cells, electrowetting pixels, electrophoretic pixels, liquid crystal display (LCD) components, or other suitable pixel structures. The lateral area of display module 94 may, for example, determine the size of the active area of display 14 (e.g., active area AA of FIG. 1). Display module 94 may include active light emitting components, touch sensor components (e.g., touch sensor electrodes), force sensor components, and/or other active components. Because display module 94 includes conductive components, display module 94 may block radio-frequency signals from passing through display 14. Antenna module 72 of FIG. 6 may therefore be located within regions 96 around the periphery of display module 94 and device 10. One or more regions 96 of FIG. 7 may, for example, include a corresponding antenna module 72. Apertures may be formed within peripheral conductive housing structures 12W within regions 96 to allow the antennas in antenna module 72 to convey radio-frequency signals to and/or from the exterior of device 10 (e.g., through the apertures).

In the example of FIG. 7, each region 96 is located along a respective side (edge) of device 10 (e.g., along the top conductive sidewall of device 10 within region 20, along the bottom conductive sidewall of device 10 within region 22, along the left conductive sidewall of device 10, and along the right conductive sidewall of device 10). Antennas mounted in these regions may provide millimeter and centimeter wave communications coverage for device 10 around the lateral periphery of device 10. When combined with the contribution of antennas that radiate through the front and/or rear faces of device 10, the antennas in device 10 may provide a full sphere of millimeter/centimeter wave coverage around device 10. The example of FIG. 7 is merely illustrative. Each edge of device 10 may include multiple regions 96 and some edges of device 10 may include no regions 96. If desired, additional regions 96 may be located elsewhere on device 10.

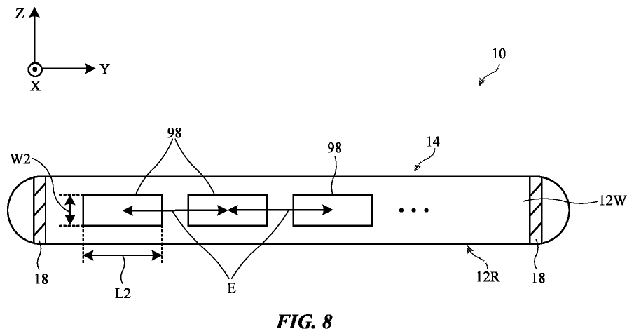

FIG. 8 is a side view showing how apertures may be formed in peripheral conductive housing structures 12W to allow the antennas in antenna module 72 to convey radio-frequency signals to and/or from the exterior of device 10 (within a given region 96 of FIG. 7). The example of FIG. 8 illustrates apertures that may be formed in the right-most region 96 of FIG. 7 (e.g., along the right conductive sidewall as viewed in the direction of arrow 97 of FIG. 7). Similar apertures may be formed in any desired conductive sidewall of device 10.

As shown in FIG. 8, device 10 may have a first (front) face defined by display 14 and a second (rear) face defined by rear housing wall 12R. Display 14 may be mounted to peripheral conductive structures 12W, which extend from the rear face to the front face and around the periphery of device 10. One or more gaps 18 may extend from the rear face to the front face to divide peripheral conductive housing structures 12W into different segments.

One or more antenna apertures such as apertures 98 may be formed in peripheral conductive housing structures 12W. Apertures 98 (sometimes referred to herein as slots 98) may be filled with one or more dielectric materials and may have edges that are defined by the conductive material in peripheral conductive housing structures 12W. Antenna module 72 of FIG. 6 may be mounted within the interior of device 10 (e.g., with the antennas facing apertures 98). Each aperture 98 may be aligned with a respective antenna 40 in the antenna module. The center of each aperture 98 may therefore be separated from the center of one or two adjacent apertures 98 by distance E.

In addition to allowing radio-frequency signals to pass between the antenna module and the exterior of device 10, apertures 98 may also form waveguide radiators for the antennas in the antenna module, if desired. For example, the radio-frequency signals conveyed by the antennas may excite one or more electromagnetic waveguide (cavity) modes within apertures 98, which contribute to the overall resonance and frequency response of the antennas in the antenna module.

Apertures 98 may have any desired shape. In the example of FIG. 8, apertures 98 are rectangular. Each aperture 98 may have a corresponding length L2 and width W2. Length L2 and width W2 may be selected establish resonant cavity modes within apertures 98 (e.g., electromagnetic waveguide modes that contribute to the radiative response of antennas 40). Length L2 may, for example, be selected to establish a horizontally-polarized resonant cavity mode for aperture 98 and width W2 may be selected to establish a vertically-polarized resonant cavity mode for aperture 98.

At the same time, if care is not taken, impedance discontinuities between the antennas in the antenna module and free space at the exterior of device 10 may introduce undesirable signal reflections and losses that limits the overall gain and efficiency for the antennas. Apertures 98 may therefore also serve as an impedance transition between the antenna module and free space at the exterior of device 10 that is free from undesirable impedance discontinuities.

In practice, it can be difficult to incorporate antennas 40 that cover each of a low band, midband, and high band into antenna module 72 while still allowing the antenna module to be aligned with apertures 98 without consuming an excessive amount of space within device 10. To allow antenna module 72 to support antennas 40 that radiate in each of the low band, midband, and high band while also allowing antenna module 72 be more flexibly placed within device 10 (such as in alignment with apertures 98), antenna module 72 may include multiple stacked substrates and the antennas 40 in antenna module may be distributed across the stacked substrates.

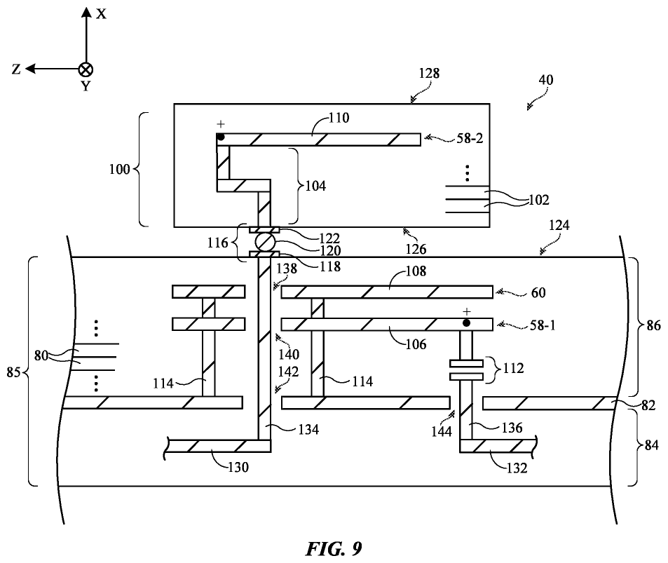

FIG. 9 is a cross-sectional top view showing one example of an antenna 40 that may radiate in the low band, midband, and high band (e.g., through a corresponding aperture 98 in peripheral conductive housing structures 12W) and that may be distributed across multiple stacked substrates in antenna module 72. As shown in FIG. 9, antenna module 72 may include an additional substrate such as substrate 100.

Substrate 100 may be mounted to a lateral (exterior) surface 124 of substrate 85. Substrate 100 may be different from, external to, and smaller than substrate 85. Substrate 85 may therefore sometimes be referred to herein as primary substrate 85 whereas substrate 100 is sometimes referred to herein as secondary substrate 100. Secondary substrate 100 may be, for example, a rigid printed circuit board, a flexible printed circuit board, a plastic substrate (e.g., a molded substrate), a polymer substrate, an interposer (e.g., a glass or silicon interposer), or another type of substrate. If desired, secondary substrate 100 may be a stacked dielectric substrate that includes multiple stacked dielectric layers 102 (e.g., multiple layers of printed circuit board substrate such as multiple layers of fiberglass-filled epoxy, polymer, silicon, rigid printed circuit board material, ceramic, polyimide, flexible printed circuit board material, plastic, glass, or other dielectrics).

Primary substrate 85 may be formed from the same type of material as secondary substrate 100 or may be formed from a different type of material than secondary substrate 100. Secondary substrate 100 is smaller than primary substrate 85 and may have a different thickness and/or shape than primary substrate 85. This may, for example, allow secondary substrate 100 to be placed at locations in device 10 that are nearby other components that would otherwise prevent primary substrate 85 from fitting at those locations. As one example, secondary substrate 100 may have a circular, elliptical, or rounded lateral outline (e.g., within the Y-Z plane) whereas primary substrate 85 has a rectangular or square lateral outline.

If desired, secondary substrate 100 may be surface-mounted to lateral surface 124 of primary substrate 85 using solder (e.g., using an array or grid of solder balls, using surface mount technology (SMT), etc.). As shown in the example of FIG. 9, solder ball 120 is used to couple a conductive contact pad 122 on lateral surface 126 of secondary substrate 100 to a conductive contact pad 118 on lateral surface 124 of primary substrate 85. Solder ball 120 and contact pads 122 and 118 may form an interconnect 116 (e.g., a solder-based interconnection or solder interconnect) between secondary substrate 100 and primary substrate 85. Interconnect 116 is external to substrates 100 and 85. Interconnect 116 may serve to mechanically secure secondary substrate 100 to primary substrate 85 and may, if desired, be used to convey signals and/or power between components on or within primary substrate 85 and components on or within secondary substrate 100.

While only a single interconnect 116 is shown in FIG. 9 for the sake of clarity, any desired number of interconnects 116 may be used to mount secondary substrate 100 to primary substrate 85 (e.g., a grid or array of interconnects 116). Some of the interconnects may include solder balls coupled to dummy pads on substrates 100 and 85 and/or ground traces on substrates 100 and 85 if desired. The example of FIG. 9 is merely illustrative. In general, interconnects 116 may include solder, adhesive, conductive pins, conductive springs, a ball grid array, a conductive bracket, and/or other conductive interconnect structures that serve to mount lateral surface 126 of secondary substrate 100 to lateral surface 124 of primary substrate 85. Some or all of the interconnects 116 may also convey signals and/or power between substrates 100 and 85.

Antenna 40 may include at least a first patch element 58-1 and a second patch element 58-2 overlapping patch element 58-1. Antenna 40 may also include at least one parasitic patch 60 overlapping patch elements 58-1 and 58-2. Patch elements 58-1 and 58-2 and parasitic patch 60 may each have respective dimensions that configure antenna 40 to collectively cover, for example, the low band (24.5-29.5 GHZ), the midband (37-43.5 GHZ), and the high band (47-48 GHz). For example, the resonance of patch element 58-1 may cover some of the low band, parasitic patch 60 may extend coverage to include all of the low band, and patch element 58-2 may further extend coverage to include the midband and the high band. This is merely illustrative and, in general, antenna 40 may cover any desired bands or frequencies.

The components of antenna 40 may be distributed between primary substrate 85 and secondary substrate 100 (e.g., through at least one interconnect 116). For example, patch element 58-1 and parasitic patch 60 may be disposed in primary substrate 85 whereas patch element 58-2 is disposed in secondary substrate 100. This is merely illustrative and, if desired, secondary substrate 100 may include one or more parasitic patches 60 (e.g., parasitic patch 60 may be disposed in secondary substrate 100 over or under patch element 58-2 instead of in primary substrate 85, additional parasitic patches 60 may be disposed in secondary substrate 100, etc.), secondary substrate 100 may include more than one overlapping patch element 58 on different dielectric layers 102, patch element 58-2 may be disposed in primary substrate 85 (e.g., patch elements 58-1 and 58-2 may both be disposed in substrate 85 whereas one or more parasitic patches 60 are disposed in secondary substrate 100), primary substrate 85 may be free from parasitic patches (e.g., parasitic patch 60 may be omitted or instead disposed in secondary substrate 100), primary substrate 85 may include more than one patch element 58 (e.g., in addition to patch element 58-2 in secondary substrate 100) and/or more than one parasitic patch 60, and/or the components of antenna 40 may be distributed across secondary substrate 100 and primary substrate 85 in any desired manner.

As shown in the example of FIG. 9, patch element 58-1 may be formed from a first conductive trace 106 (e.g., a first layer of one or more conductive traces) on a first dielectric layer 80 of primary substrate 85. Parasitic patch 60 may be formed from a second conductive trace 108 (e.g., a second layer of one or more conductive traces) on a second dielectric layer 80 of primary substrate 85 (e.g., between patch element 58-1 and lateral surface 124). Alternatively, conductive trace 108 may be disposed on lateral surface 124. Patch element 58-2 may be formed from a third conductive trace 110 (e.g., a third layer of one or more conductive traces) on a dielectric layer 102 of secondary substrate 100. Alternatively, patch element 58-2 may be formed on lateral surface 126 or lateral surface 128 of secondary substrate 100. Conductive trace 110 may overlap conductive traces 108 and 106 (e.g., when viewed in the −X direction). Conductive trace 108 may overlap conductive trace 106 and may be vertically interposed between conductive traces 110 and 106. In this way, antenna 40 may be embedded within both secondary substrate 100 and primary substrate 85.

Signal traces 130 and 132 may be patterned onto one or more of the transmission line layers 84 of primary substrate 85. A conductive via such as conductive via 136 may extend through an opening 144 in ground traces 82 to couple signal trace 132 to patch element 58-1 (e.g., at a positive antenna feed terminal for patch element 58-1 such as positive antenna feed terminals 62V or 62H of FIG. 5). If desired, impedance matching structures 112 may be disposed on conductive via 114 between signal trace 132 and patch element 58-1.

Impedance matching structures 112 may include one or more layers of conductive traces on one or more dielectric layers 102 of secondary substrate 100 and/or one or more conductive vias extending vertically through one or more dielectric layers 102. The conductive traces in impedance matching structures 112 may be coupled together by conductive vias or may be separated by gaps. The conductive traces may, for example, form one or more printed capacitors, inductors, and/or impedance matching segments of a transmission line coupled between signal trace 132 and patch element 58-1. The number, length, and width of the conductive traces and/or conductive vias in impedance matching structures 112 may be selected to perform impedance matching between patch element 58-1 and signal trace 132 at the frequencies of operation for patch element 58-1, for example.

Signal trace 132 and conductive via 136 may form part of the signal conductor of a radio-frequency transmission line path for patch element 58-1 (e.g., signal conductor 46 in radio-frequency transmission line 42 of FIG. 3, having a ground conductor formed from ground traces 82). In other words, patch element 58-1 may be fed through some of the antenna layers 86 of primary substrate 85. On the other hand, patch element 58-2 on secondary substrate 100 may be fed through primary substrate 85 (e.g., all of the antenna layers 86 in primary substrate 85) and interconnect 116.

For example, a conductive via such as conductive via 134 may couple signal trace 130 to interconnect 116. Conductive via 134 may extend from signal trace 130 through opening 142 in ground traces 82, through an opening 140 in patch element 58-1, and through an opening 138 in parasitic patch 60 to contact pad 118 at lateral surface 124. Openings 140, 138, 142, and 144 may sometimes also be referred to herein as slots or holes. Secondary substrate 100 may include impedance matching structures 104 that couple interconnect 116 (e.g., contact pad 122) to patch element 58-2 (e.g., at a positive antenna feed terminal for patch element 58-2 such as positive antenna feed terminals 62V or 62H of FIG. 5).

Impedance matching structures 104 may include one or more conductive vias extending through one or more dielectric layers 102 of secondary substrate 100 (e.g., including conductive vias coupled to patch element 58-2 and contact pad 122) and/or one or more layers of conductive traces on one or more dielectric layers 102 of secondary substrate 100. The conductive traces may, for example, form one or more printed capacitors, inductors, and/or impedance matching segments of a transmission line coupled between signal trace 130 and patch element 58-2. The number, length, and width of the conductive traces and/or conductive vias may be selected to perform impedance matching between patch element 58-2 and signal trace 130 at the frequencies of operation for patch element 58-2, for example. If desired, external impedance matching components (e.g., SMT components) may be mounted to a surface of primary substrate 85 and/or secondary substrate 100 and may be coupled to the signal paths for patch elements 58-1 and/or 58-2 to perform impedance matching in addition to or instead of embedded impedance matching structures 104 and 112.

Signal trace 130, conductive via 136, and impedance matching structures 104 may form part of the signal conductor of a radio-frequency transmission line path for patch element 58-1 (e.g., signal conductor 46 in radio-frequency transmission line 42 of FIG. 3 and having a ground conductor formed from ground traces 82). If desired, some or all of parasitic patch 60 and/or patch element 58-1 may form part of the reference ground (antenna ground) for patch element 58-2 at the resonant frequencies of patch element 58-2. If desired, secondary substrate 100 may include ground traces (not shown) on one or more dielectric layers 102 and/or on lateral surface 126 that additionally or alternatively form the reference ground for patch element 58-2.

If desired, one or more conductive vias 114 may couple patch element 58-1 and/or parasitic patch 60 to ground traces 82 through the antenna layers 86 of primary substrate 85. Conductive vias 114 may, for example, include a fence of conductive vias that laterally surrounds conductive via 134 and openings 142, 140, and 138 (e.g., in the Y-Z plane). Conductive vias 114 may serve to shield conductive via 134 and thus the signal conductor for patch element 58-2 from interference from low band signals on patch element 58-1 and parasitic patch 60. In this way, the excitation of patch element 58-2 in the midband and high band may be electrically separated from the excitation of patch element 58-1 in the low band. This electrical separation may allow for relatively high isolation (e.g., greater than 15 dB) between patch element 58-1 and parasitic patch 60 in the low band and patch element 58-2 in the midband and high band. The electrical separation may also allow the architecture of the low band patches to be optimized independently from that of the midband/high band patch.

If desired, some or all of the active components used to support antenna 40 may be disposed on or mounted to secondary substrate 100 instead of primary substrate 85 (e.g., some or all of the active components of RFIC 74 of FIG. 6 may be distributed between primary substrate 85 and secondary substrate 100). The active components may include, for example, an antenna tuner, a transceiver, phase and magnitude controllers (e.g., beam steering circuitry), an IC that covers baseband to radio frequencies, etc.

The example of FIG. 9 shows only a single positive antenna feed terminal on patch elements 58-1 and 58-2 for the sake of clarity. If desired, patch element 58-1 and/or patch element 58-2 may have two positive antenna feed terminals (e.g., positive antenna feed terminals 62H and 62V of FIG. 5) for covering multiple polarizations.

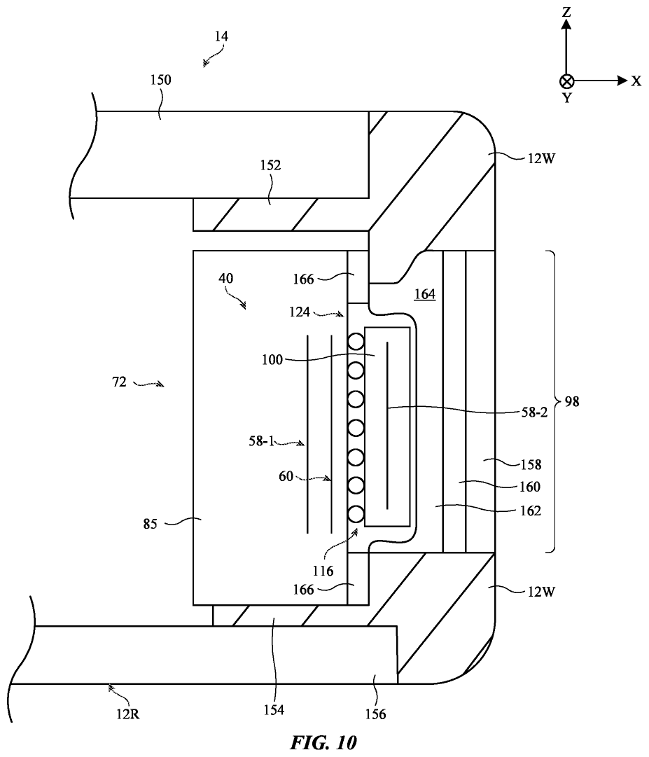

FIG. 10 is a cross-sectional side view showing how antenna module 72 of FIG. 9 may be mounted within device 10 in alignment with a corresponding aperture 98 in peripheral conductive housing structures 12W (e.g., as taken at the location of a given antenna 40 in the antenna module). As shown in FIG. 10, display 14 may include a display cover layer 150 that is mounted to ledge (datum) 152 of peripheral conductive housing structures 12W. Aperture 98 may be formed in peripheral conductive housing structures 12W. Rear housing wall 12R may extend from peripheral conductive housing structures 12W opposite display cover layer 150. Rear housing wall 12R may include a dielectric cover layer 156 if desired. Dielectric cover layer 156 may be formed from glass, plastic, ceramic, or other materials. Peripheral conductive housing structures 12W may include a ledge (datum) 154 that extends along dielectric cover layer 156 and/or that forms part of rear housing wall 12R.

Aperture 98 may include a cavity formed in peripheral conductive housing structures 12W. A dielectric substrate such as dielectric substrate 164 may be disposed within the cavity. Dielectric substrate 164 may be formed from injection molded plastic, as one example. Dielectric cover layer 158 may also be mounted within the cavity. Dielectric cover layer 158 may have an inner surface that is coupled to dielectric substrate 164 by adhesive 160. Dielectric cover layer 158 also has an outer surface at the exterior of device 10. The outer surface of dielectric cover layer 158 may, for example, lie flush with exterior surface of peripheral conductive housing structures 12W. Dielectric cover layer 158 may also sometimes be referred to herein as dielectric antenna window 158.

Antenna module 72 may be aligned with aperture 98 and may be mounted against dielectric substrate 164 and peripheral conductive housing structures 12W. Some or all of antenna module 72 (e.g., primary substrate 85) may be vertically interposed between ledge 152 and ledge 154. If desired, primary substrate 85 may be attached to peripheral conductive housing structures 12W using adhesive 166. When mounted in this way, secondary substrate 100 may protrude into the cavity of aperture 98. If desired, dielectric substrate 164 may have a cavity or recessed portion that accommodates secondary substrate 100 (e.g., secondary substrate 100 may be disposed within the recessed portion of dielectric substrate 164). Alternatively, dielectric substrate 164 may be molded onto secondary substrate 100.

The shape and size of secondary substrate 100 may be selected to fit within the cavity of aperture 98. Secondary substrate 100 may, for example, be smaller than primary substrate 85 and may have a shape that matches or fits within the recessed portion of dielectric substrate 164 and/or the cavity of aperture 98. This may allow secondary substrate 100 to protrude farther into aperture 98 than primary substrate 85 would otherwise be able to protrude. This places patch element 58-2 closer to dielectric antenna window 158 and free space than in implementations where patch element 58-2 is embedded in primary substrate 85. This may serve to boost the performance of antenna 40 across each of the low band, midband, and high band (e.g., increasing gain by 0.5-2.5 dB across all of the bands).

The example of FIG. 10 is merely illustrative. In general, antenna module 72 may be disposed at other locations in device 10. The small size and adaptable form factor of secondary substrate 100 may allow antenna module 72 to be placed at a greater number of locations in device 10 (while exhibiting consistent or improved antenna performance) than in scenarios where antenna module 72 includes only primary substrate 85, given the other components that may be present in device 10.

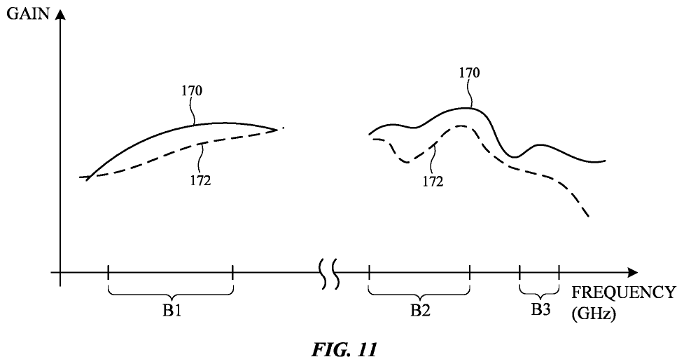

FIG. 11 is a plot of antenna gain as a function of frequency showing how distributing antenna 40 across primary substrate 85 and secondary substrate 100 in antenna module 72 may optimize antenna performance. Curves 172 of FIG. 11 plot the gain of antenna 40 in an implementation where antenna module 72 includes only primary substrate 85 (e.g., where patch elements 58-1 and 58-2 and parasitic patch 60 are all disposed in primary substrate 85). Curves 170 of FIG. 11 plot the gain of antenna 40 as distributed across primary substrate 85 and secondary substrate 100 (e.g., as shown in FIGS. 9 and 10).

As shown by curves 170 and 172, distributing antenna 40 across primary substrate 85 and secondary substrate 100 may increase the gain of antenna 40 across multiple bands such as a first band B1 (e.g., the low band), a second band B2 (e.g., the midband), and a third band B3 (e.g., the high band) (e.g., by as much as 0.5-2.5 dB) relative to embedding all of antenna 40 within a single substrate. The example of FIG. 11 is merely illustrative and, in practice, curves 170 and 172 may have other shapes. Antenna 40 may cover any desired frequencies.

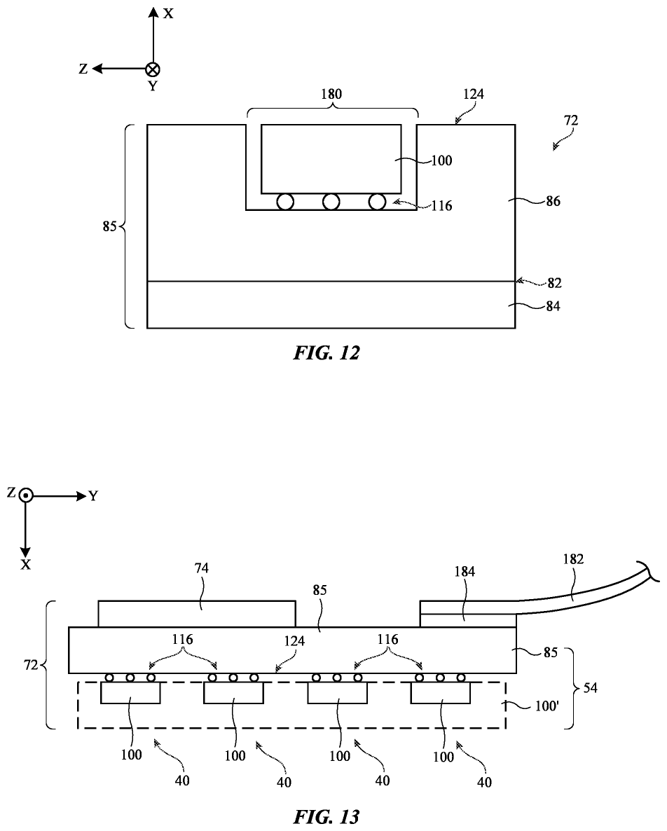

In the example of FIGS. 9 and 10, an entirety of secondary substrate 100 lies above lateral surface 124 of primary substrate 85. This is merely illustrative. If desired, secondary substrate 100 may be recessed within primary substrate 85. FIG. 12 is a top view showing one example of how secondary substrate 100 may be recessed within primary substrate 85.

As shown in FIG. 12, primary substrate 85 may have a recess 180 in lateral surface 124. Recess 180 may sometimes also be referred to herein as cavity 180. Secondary substrate 100 may be mounted to lateral surface 124 of primary substrate 85 within recess 180 (e.g., interconnects 116 may couple secondary substrate 100 to primary substrate 85 within recess 180). An entirety of secondary substrate 100 may lie within recess 180 or, if desired, some of secondary substrate 100 may protrude out of recess 180.

FIG. 13 is a bottom view showing an example in which primary substrate 85 is formed from a rigid material (e.g., as a rigid printed circuit board). As shown in FIG. 13, RFIC 74 and connector 184 may be disposed on surface 76 of primary substrate 85. A cable or printed circuit 182 may couple connector 184 to other components in device 10 (e.g., a main logic board). Connector 184 and cable 182 may carry radio-frequency signals, intermediate frequency signals, baseband signals, control signals, power, or other signals between antenna module 72 and other components (e.g., a main logic board).

If desired, each antenna 40 in phased antenna array 54 may be distributed between primary substrate 85 and a different respective secondary substrate 100 mounted to lateral surface 124 of primary substrate 85 using different respective interconnects 116. For example, the patch element 58-2 (FIG. 9) of each antenna 40 in phased antenna array 54 may be disposed in a different respective secondary substrate 100.

Alternatively, two or more of the antennas 40 in phased antenna array 54 may be distributed between primary substrate 85 and the same secondary substrate 100. For example, all of the antennas 40 in phased antenna array 54 may be distributed between primary substrate 85 and the same secondary substrate 100′. Secondary substrate 100′ may be smaller than primary substrate 85 and may have a different shape than primary substrate 85, which may allow secondary substrate 100′ to fit at locations in device 10 where primary substrate 85 would otherwise not fit (e.g., within a single elongated aperture 98 in peripheral conductive housing structures 12W).

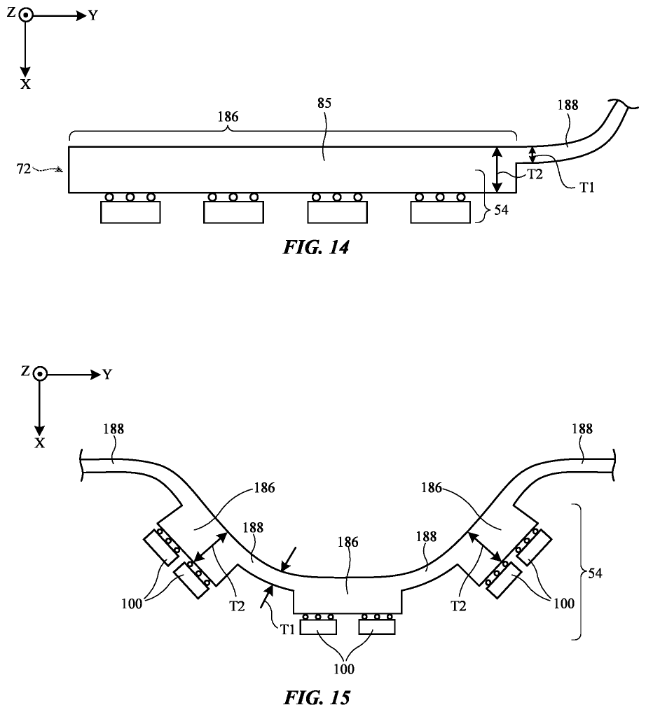

FIG. 14 is a bottom view showing an example in which primary substrate 85 is formed from a flexible material (e.g., as a flexible printed circuit board). As shown in FIG. 14, primary substrate 85 may be formed from a flexible printed circuit board having a first portion 186 and a second portion 188 (e.g., a tail portion) that extends away from first portion 186. Portion 188 may have a first thickness T1 and portion 186 may have a second thickness T2 that is greater than first thickness T1. Portion 188 may sometimes be referred to herein as thinner portion 188 whereas portion 186 is sometimes referred to herein as thicker portion 186 or tail 186.

Phased antenna array 54 may be mounted to portion 186 of primary substrate 85. Increasing the thickness of primary substrate 85 within portion 186 of primary substrate 85 in this way may serve to optimize the performance of the antennas in phased antenna array 54 (e.g., by maximizing antenna bandwidth).

If desired, different antennas in phased antenna array 54 may be oriented at different angles on a primary substrate 85 formed from flexible printed circuit material. FIG. 15 is a bottom view showing an example in which primary substrate 85 is formed from a flexible material and different antennas in phased antenna array 54 are oriented at different angles on primary substrate 85.

As shown in FIG. 15, primary substrate 85 may include multiple portions 186 having thickness T2 and multiple thinner portions 188 having thickness T1. Portions 188 may be bent or folded to orient thicker portions 186 in different directions. One or more secondary substrates 100 from phased antenna array 54 may be mounted to each portion 186 of primary substrate 85. In this way, different antennas in phased antenna array 54 may be oriented in different directions. Alternatively, the antennas associated with each secondary substrate 100 may be independent antennas that are not part of the same phased antenna array, the antennas associated with the secondary substrates 100 on each portion 186 may form different respective phased antenna arrays oriented in different directions, etc.

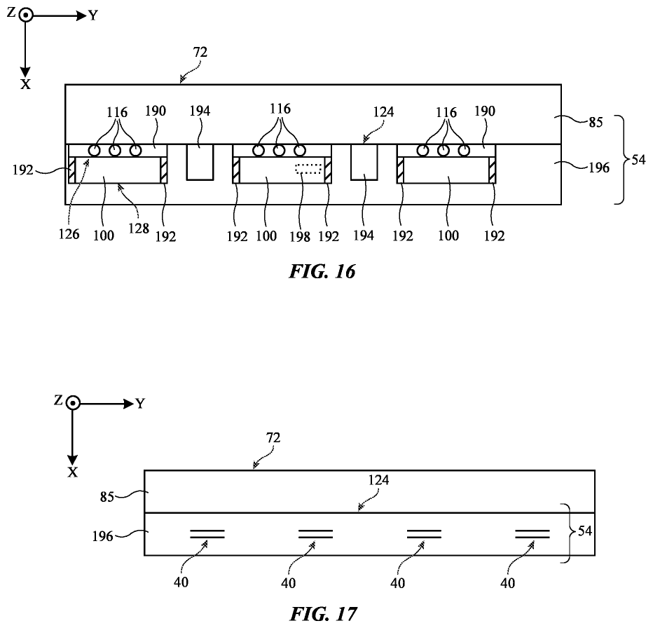

FIG. 16 is a cross-sectional bottom view showing additional structures that may be formed in antenna module 72 for supporting phased antenna array 54. As shown in FIG. 16, an underfill 190 may be provided over the interconnect structures 116 between secondary substrates 100 and primary substrate 85 if desired. Additionally or alternatively, an edge metallization 192 may be provided along the vertical edges of secondary substrates 100. Edge metallization 192 may be laterally interposed between a given antenna 40 and the antenna 40 of the adjacent secondary substrate 100. Edge metallization 192 may, for example, help to increase isolation between the antennas in phased antenna array 54.

Additionally or alternatively, one or more electrical components 194 may be mounted to lateral surface 124 of primary substrate 85 (e.g., using solder). Electrical components 194 may include some or all of the active components of RFIC 74 of FIG. 6, impedance matching circuitry for antennas 40, tuning circuitry, transceiver circuitry, phase and magnitude controllers, active integrated circuits, passive circuit components, etc. Additionally or alternatively, one or more electrical components 194 may be embedded within one or more secondary substrates 100, such as at location 198.

Additionally or alternatively, an encapsulation layer such as encapsulation layer 196 may be molded over some or all of the secondary substrates 100 and/or electrical components 194 on primary substrate 85. If desired, secondary substrates 100 may be omitted and the antennas 40 in phased antenna array 54 may be embedded within encapsulation layer 196, as shown in FIG. 17.

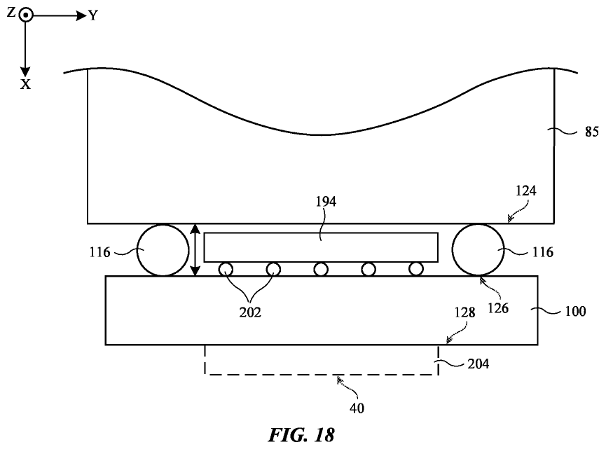

Additionally or alternatively, electrical components 194 may be mounted to a lateral surface of secondary substrate 100. For example, as shown in FIG. 18, electrical component 194 may be mounted to lateral surface 126 of secondary substrate 100 using interconnects 202 (e.g., in a flip-chip configuration). Interconnects 202 may include solder, adhesive, conductive pins, conductive springs, a ball grid array, a conductive bracket, and/or other conductive interconnect structures that serve to mount lateral surface 126 of secondary substrate 100 to electrical component 194. If desired, some or all of the interconnects 202 may also convey signals and/or power between electrical component 194 and secondary substrate 100.

When mounted to lateral surface 126, electrical component 194 may be vertically interposed between primary substrate 85 and secondary substrate 100 (e.g., within a cavity 200 between interconnects 116 and between substrates 85 and 100). Additionally or alternatively, electrical component 194 may be mounted to lateral surface 128 (e.g., at location 204). In general, any of the arrangements of FIGS. 12-18 may be combined if desired.

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made by those skilled in the art without departing from the scope and spirit of the described embodiments. The foregoing embodiments may be implemented individually or in any combination.

What is claimed is:

1. An electronic device comprising:
a first substrate;
a second substrate mounted to a surface of the first substrate by an interconnect;
a first patch in the first substrate and configured to radiate at a first frequency;
a first antenna feed terminal on the first patch;
a second patch in the second substrate and overlapping the first patch in the first substrate, the second patch being configured to radiate at a second frequency; and
a second antenna feed terminal on the second patch and coupled to the interconnect.

2. The electronic device of claim 1, further comprising:
a first signal trace in the first substrate;
a first conductive via in the first substrate that couples the first signal trace to the first antenna feed terminal;
a second signal trace in the first substrate; and
a second conductive via in the first substrate that couples the second signal trace to the interconnect.

3. The electronic device of claim 2, further comprising:
ground traces in the first substrate, the first patch being interposed between the ground traces and the surface of the first substrate.

4. The electronic device of claim 3, wherein the second conductive via extends through a hole in the first patch.

5. The electronic device of claim 4, further comprising:
a set of conductive vias that couples the first patch to the ground traces and that laterally surrounds the hole in the first patch.

6. The electronic device of claim 5, further comprising:
a parasitic patch on the first substrate and interposed between the first patch and the surface of the first substrate, wherein the second conductive via extends through a hole in the parasitic patch.

7. The electronic device of claim 6, wherein the set of conductive vias couples the parasitic patch to the first patch.

8. The electronic device of claim 1, wherein the interconnect comprises a solder ball.

9. The electronic device of claim 1, wherein the second substrate is smaller than the first substrate.

10. The electronic device of claim 9, further comprising:
peripheral conductive housing structures; and
an aperture in the peripheral conductive housing structures, wherein the first patch and the second patch are aligned with the aperture and the second substrate protrudes into the aperture.

11. The electronic device of claim 1, wherein the first substrate comprises a cavity and the second substrate is mounted to the surface of the first substrate within the cavity.

12. An electronic device comprising:
a first substrate;
a second substrate mounted to the first substrate;
solder that couples the first substrate to the second substrate;
an antenna having a first patch in the first substrate and a second patch in the second substrate, the second patch overlapping the first patch;
first and second signal traces in the first substrate;
first and second conductive vias in the first substrate, wherein the first conductive via couples the first signal trace to the first patch; and
a third conductive via in the second substrate, wherein the second signal trace is coupled to the second patch through the second conductive via, the solder, and the third conductive via.

13. The electronic device of claim 12, further comprising:
an impedance matching structure disposed on the third conductive via.

14. The electronic device of claim 12, further comprising:
an additional antenna having a third patch in the first substrate and a fourth patch in the second substrate, the fourth patch overlapping the third patch, and the antenna and the additional antenna forming part of a phased antenna array.

15. The electronic device of claim 12, further comprising:
a third substrate mounted to the first substrate;
additional solder that couples the first substrate to the third substrate; and
an additional antenna having a third patch in the first substrate and a fourth patch in the third substrate, the fourth patch overlapping the third patch.

16. The electronic device of claim 15, wherein the first substrate has a first portion with a first thickness, a second portion with a second thickness, and a third portion that couples the first portion to the second portion and that has a third thickness less than the first and second thicknesses, the second substrate being mounted to the first portion and the third substrate being mounted to the second portion.

17. The electronic device of claim 12, further comprising:
an integrated circuit mounted to the second substrate and interposed between the first and second substrates.

18. The electronic device of claim 12, wherein the second conductive via passes through a hole in the first patch.

19. An electronic device comprising:
a display;
peripheral conductive housing structures mounted to the display and extending along a periphery of the display;
an aperture defining a cavity in the peripheral conductive housing structures;
a first substrate;
a second substrate surface-mounted to the first substrate, the second substrate being smaller than the first substrate and extending into the cavity; and
an antenna having a first patch in the first substrate and a second patch in the second substrate, the antenna being configured to convey radio-frequency signals through the aperture.

20. The electronic device of claim 19, further comprising:
first and second signal traces in the first substrate;
a first conductive via in the first substrate that couples the first signal trace to the first patch;
a second conductive via in the second substrate and coupled to the second patch; and
a third conductive via in the first substrate that couples the second signal trace to the second conductive via through a hole in the first patch.
